(19) United States
(12) Patent Application Publication
(10) Pub. No.: US 2026/0187346 A1
(43) Pub. Date: Jul. 2, 2026

(54) SUMMARIZING ACTIVITY HISTORY OF USER BASED ON INTERMEDIATE REPRESENTATION

(71) Applicant: Google LLC, Mountain View, CA (US)

(72) Inventors: Devora Berlowitz, Seattle, WA (US); Jonathan Berant, Seattle, WA (US)

(21) Appl. No.: 19/008,249

(22) Filed: Jan. 2, 2025

(51) Int. Cl. G06F 40/166; G06F 40/30; G06F 40/40

(52) U.S. Cl. CPC G06F 40/166; G06F 40/30; G06F 40/40

(57) ABSTRACT

A method can include generating, using a language model, an intermediate representation of an activity history of a user account based on actions performed with respect to a browser; generating, using the language model, a first textual summary for a first intent based on the intermediate representation; generating, using the language model, a second textual summary of a second intent based on the intermediate representation; associating the first textual summary and the second textual summary with the user account; selecting, from the first textual summary and the second textual summary, a selected summary based on a requested intent; and providing content based on the selected summary.

### TECHNICAL FIELD

This description relates to language models.

### BACKGROUND

Browsing histories of the user accounts can be helpful to determine content that users may find interesting, where user permission for storing such histories is obtained. However, analyzing user histories for different potential applications, activities, or interests can be expensive in terms of both resource consumption and processor cycles.

### SUMMARY

Implementations relate to generating multiple textual summaries for various intents. The textual summaries are summaries of intents of a user account based on actions performed while using (e.g., with respect to) a browser. To generate the textual summaries, an intermediate representation of the activity history is generated. In some examples, the intermediate representation includes a key-value cache. A language model can generate multiple textual summaries of multiple intents based on the intermediate representation. In some examples, the language model generates the multiple textual summaries for different intents that can apply to different applications and/or for different use cases. The multiple textual summaries can be generated in response to requests, such as prompts, that relate to the different intents. The summaries are stored, with user permission, in association with a user account. The summaries may be stored in association with an indication of the intent. The indication can be an indication of the application that requested the intent. The indication can be an indication of the prompt used to generate the summary. Content can be provided based on one or more of the textual summaries.

According to an example, a method can include generating, using a language model, an intermediate representation of an activity history of a user account based on actions performed with respect to a browser; generating, using the language model, a first textual summary for a first intent based on the intermediate representation; generating, using the language model, a second textual summary of a second intent based on the intermediate representation; associating the first textual summary and the second textual summary with the user account; selecting, from the first textual summary and the second textual summary, a selected summary based on a requested intent; and providing content based on the selected summary.

A non-transitory computer-readable storage medium comprising instructions stored thereon. When executed by at least one processor, the instructions configured to cause a computing system to generate, using a language model, an intermediate representation of an activity history of a user account based on actions performed with respect to a browser; generate, using the language model, a first textual summary for a first intent based on the intermediate representation; generate, using the language model, a second textual summary of a second intent based on the intermediate representation; associate the first textual summary and the second textual summary with the user account; select, from the first textual summary and the second textual summary, a selected summary based on a requested intent; and provide content based on the selected summary.

A computing system includes at least one processor and a non-transitory computer-readable storage medium comprising instructions stored thereon. When executed by the at least one processor, the instructions are configured to cause the computing system to generate, using a language model, an intermediate representation of an activity history of a user account based on actions performed with respect to a browser; generate, using the language model, a first textual summary for a first intent based on the intermediate representation; generate, using the language model, a second textual summary of a second intent based on the intermediate representation; associate the first textual summary and the second textual summary with the user account; select, from the first textual summary and the second textual summary, a selected summary based on a requested intent; and provide content based on the selected summary.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram showing transformations of data from activity history to multiple textual summaries.

FIG. 2 shows a browser generating activity history of a user account.

FIG. 3 shows generation of textual summaries of activity history of a user account based on an intermediate representation of the activity history and intents.

FIG. 4 shows generation of individualized content for a user account based on a textual summary.

FIG. 5 is a block diagram of a computing system.

FIG. 6 is a flowchart showing a method performed by the computing system.

Like reference numbers refer to like elements.

### DETAILED DESCRIPTION

A technical problem with determining content that users may find interesting is the complexity of analyzing user data. Analyzing user data can be computationally expensive, especially if the user data are analyzed multiple times for determining different intents with respect to multiple applications. For example, different applications may have need of different use cases based on the history, and/or have need of different types of data/patterns/areas of interest from the history. The different use cases, data, patterns, areas of interest are expressed as intents. A platform can have a high number of active user accounts, such as millions or billions of user accounts. The user accounts can each have a long history of actions and/or user data. Processing the long histories of actions for the high number of active user accounts can consume large amounts of computing resources.

A technical solution to this technical problem is to generate and reuse an intermediate representation of the user data to generate multiple summaries of the data, each addressing a different intent. A language model can generate user profile summaries (also referred to as textual summaries) based on the intermediate representation. The intermediate representation can include a key-value cache (KV cache). A computing system can generate the different profile summaries of the same user account with respect to different intents. A computing system can, for example, request the language model to generate textual summaries of multiple different intents of the user account based on the intermediate representation. The computing system can, for example, present prompts to the language model requesting summaries of user attributes, such as interests of the user, with respect to the different intents. This technical solution has the technical benefit of reducing the computational cost of generating intent summaries for the user profile by reusing the intermediate representation to generate multiple different textual summaries.

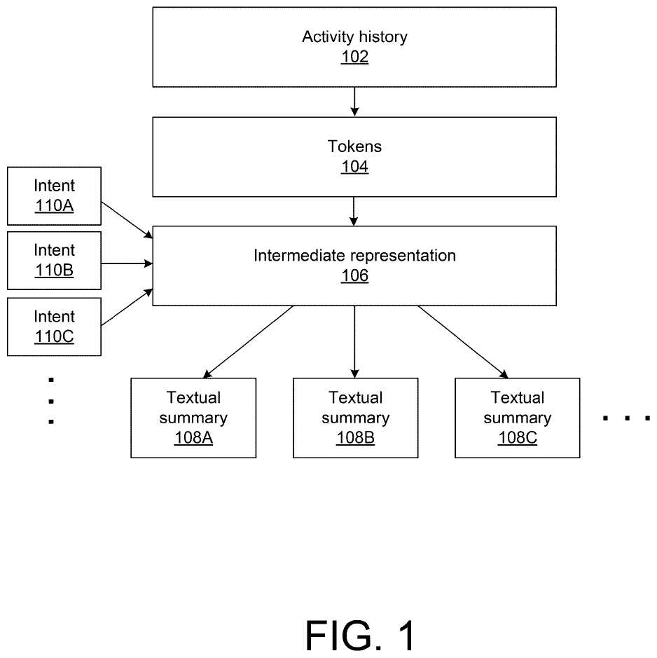

FIG. 1 is a block diagram showing transformations of data from activity history 102 to multiple textual summaries 108A, 108B, 108C based on multiple intents 110A, 110B, 110C. The activity history 102 can include activity associated with a user account, obtained in accordance with user permission. The activity history 102 can include actions performed with respect to a browser, such as a web browser. In some examples, the activity history 102 includes a search history including search queries, selections of webpages within presented search results (such as clicks on search results that are presented to a user who is logged in with the user account), and/or time spent within webpages (dwell time) that are selected from the search results. In some examples, the activity history 102 includes webpages visited, time spent at the webpages (dwell time), and/or interactions with the webpages such as clicks on links within webpages and/or entry of text into fields of the webpages. The activity history 102 can store these actions in the chronological order in which the actions occurred. With user permission, the activity history 102 can be stored by a server with which the user account is logged into and/or authenticated.

The activity history 102 can be transformed into a structured format of tokens 104. Each token within the tokens 104 can represent a specific action performed by a user account with respect to an object. Examples of tokens are, “search_query: mobile_phone,” which represents a search query with the query terms, “mobile phone;” “click: product_link,” which represents a click, tap, or other selection of a hyperlink related to a specific product; or, “watch_video: travel_vlog,” which represents watching a video about a travel log. The tokens 104 can be stored in chronological order, or stored as an unordered set.

An intermediate representation 106 can be generated based on the tokens 104. The intermediate representation 106 can be generated based on attention maps. An attention map is a layer of a transformer architecture, such as the architecture used in a large language model. The attention maps can be generated by a model, such as a large language model, based on the tokens 104. The attention maps indicate the importance of each token within the sequence of tokens 104 relative to other tokens within the sequence of tokens 104. The intermediate representation 106 can be generated based on the attention maps. Thus, the intermediate representation 106 can reflect and/or indicate relationships between the actions (represented by tokens) performed with respect to the browser.

The intermediate representation 106 can include a key-value (KV) cache. The system can generate the KV cache based on the attention maps. The system caches key-value pairs for each token of the tokens 104. A KV cache avoids redundant calculations by storing previously-computed values and updating only a single row and column for each new token, causing the complexity to grow linearly with the number of tokens rather than quadratically. Key-value attention states of input tokens can be reused during the autoregressive token generation, eliminating the need to compute full attention for every token. By caching the key-value attention states computed for a previously-generated token, each token computes the key-value attention state only once.

The intermediate representation 106 (such as a KV cache) represents, for each token of the tokens 104, a measure of relatedness to the other tokens 104. The relatedness can indicate, for example, whether actions represented by tokens frequently occur proximally to each other (proximity can indicate chronological proximity which may be measured in seconds or other units of time, or proximity within an order of events or actions which may be measured as a number of tokens in distance). The relatedness can indicate, for example, whether a user account may be interested in a particular product or service while visiting a webpage presenting a similar or related product or service.

Textual summaries 108A, 108B, 108C can be generated based on the intermediate representation 106, with each textual summary corresponding with a respective intent 110A, 110B, 110C. The textual summaries 108A, 108B, 108C can be considered textual user profile summaries for intents. Each intent may be associated with a particular application or applications. Put another way, each application may have a particular focus or use case (intent) for which the profile summary is generated. The textual user profile summaries are based on browser activity history of the user account. The textual user profile summaries reflect attributes of (e.g., preferences and interests of) the user account.

The textual summaries 108A, 108B, 108C can each be related to different intents such as applications, activities, and/or areas of interest. The textual summaries 108A, 108B, 108C can each be related to different intents (e.g., textual summary 108A can be related to intent 110A) with respect to the user account associated with the activity history 102, tokens 104, and/or intermediate representation 106. For example, one textual summary may have been generated in response to an intent that requests recent listening habits and favorite genres to benefit a music application, another textual summary may have been generated in response to an intent that relates to reading patterns and topical interests to benefit a news application, and another textual summary may have been generated in response to an intent relating to purchase history and product preferences to benefit an e-commerce site. In some implementations, the textual summaries are associated with an indication of the intent. The indication of the intent may include an identifier for the application that requested the intent. In some implementations, the indication of the intent includes an identifier for the prompt used to generate the summary or an embedding of the prompt, etc. The intermediate representation 106 is reused to generate the multiple textual summaries 108A, 108B, 108C. Because the computational cost of generating the intermediate representation 106 is high, reusing the intermediate representation 106 enables the system to meet different application needs (intents) while reducing computational costs. Different application needs can include hotel recommendations, personalized search results, advertisement targeting, or semantic tokens that will be used by additional downstream models, as non-limiting examples.

In some examples, the textual summaries 108A, 108B, 108C can be generated by a language model. The language model can generate each of the textual summaries 108A, 108B, 108C in response to a request to provide a textual summary of an intent based on the intermediate representation 106. The request to provide the textual summary for the intent can include a prompt, or textual query, provided to the language model. The prompt or textual query is a sequence of characters for words that can indicate an intent. The intent can represent any information the requesting application wants to know about the history, such as an area of interest, activity, attribute, or application that implies a use case, and can indicate or imply the user account (such as by referring to, “the user,” or a similar phrase). In some implementations, the intermediate representation 106 may be deleted after the various textual summaries have been generated. In some implementations, the intermediate representation 106 can be stored for later use (e.g., generating an additional textual summary or in some other context). In some implementations, a stored intermediate representation 106 can be updated to reflect additional user activity history.

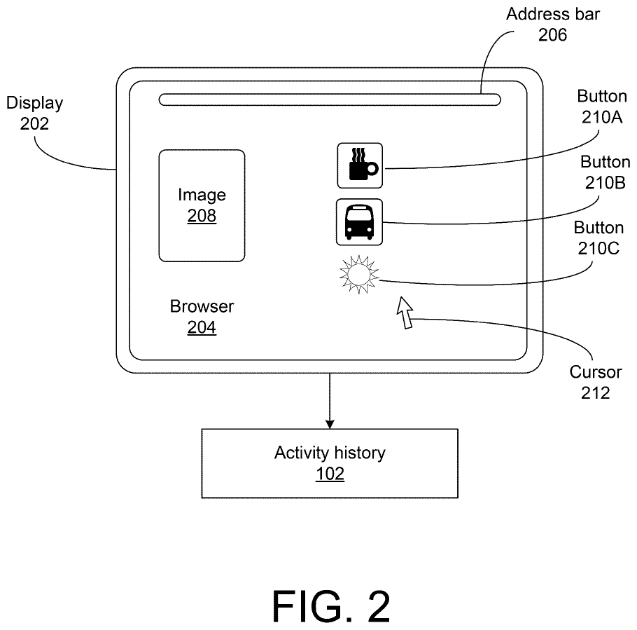

FIG. 2 shows a browser 204 generating activity history of a user account. The browser 204 can be presented by a display 202. The display 202 can be coupled to and/or controlled by a computing system, such as a desktop computer, a laptop or notebook computer, a tablet, or a mobile phone such as a smartphone. With explicit permission of the user who has logged into the user account, the activity of the user account with respect to the browser 204 can be monitored and/or stored to generate the activity history 102.

The browser 204 can include an address bar 206. The address bar 206 can receive query terms and/or a search query, or a uniform resource locator (URL) that identifies a webpage. The browser 204 can respond to text entered into the address bar 206 by sending the query terms and/or search query to a search engine and presenting the search results within the browser 204, and/or by requesting a file (such as a webpage) identified by the URL. With user permission, text entered into the address bar 206 can be a browser activity stored in the activity history 102 based on which a token of the tokens 104 is generated.

The browser 204 can, for example, present at least one image 208. The image 208 can be included in a webpage rendered by the browser 204. The activity history 102 can include the frequency at which the user account views images with similar content to the at least one image 208, and/or the time such as dwell time that the user account views images with similar content as the at least one image 208.

The browser 204 can include and/or present buttons 210A, 210B, 210C that are included in the webpage rendered by the browser 204. The buttons 210A, 210B, 210C can include icons and/or text associated with content. In some implementations, the association with content is based on images and/or text included in the buttons 210A, 210B, 210C. In some examples, the association with content is based on content included in webpages linked to by the buttons 210A, 210B, 210C. In some implementations, the buttons 210A, 210B, 210C are associated with and/or include hyperlinks to other webpages. The user logged into the user account can select buttons 210A, 210B, 210C by tapping, pressing, or clicking on the buttons 210A, 210B, 210C. Tapping, pressing, or clicking on the buttons 210A, 210B, 210C can include moving and/or hovering a cursor 212 presented by the display 202 over one or more of the buttons 210A, 210B, 210C. The activity history 102 can include interactions of the user account with content associated with the buttons 210A, 210B, 210C, such as tapping, pressing, or clicking on the buttons 210A, 210B, 210C.

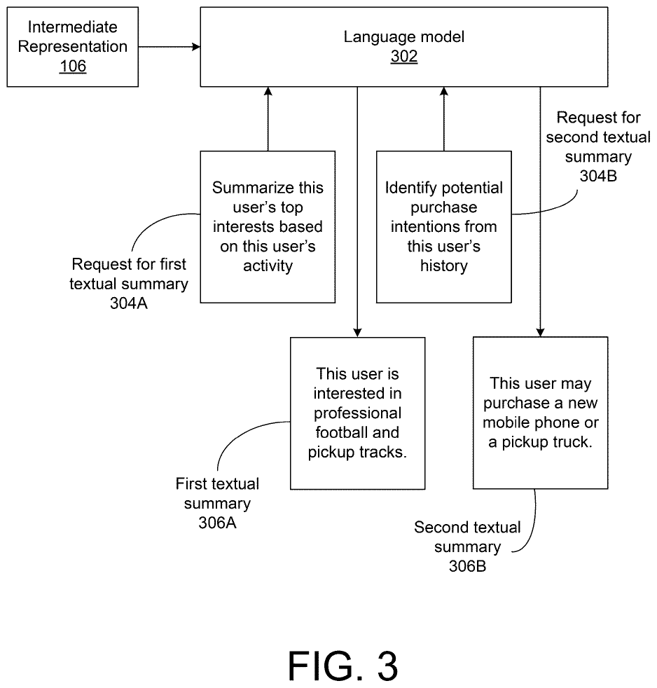

FIG. 3 shows generation of textual summaries 306A, 306B of activity history 102 of a user account based on the intermediate representation 106 of the activity history 102. A language model 302 can receive as inputs the intermediate representation 106 and multiple requests for textual summaries 304A, 304B. The requests for textual summaries 304A, 304B are examples of intents. The language model 302 can include a generative language model (large language model, small language model) based on a transformer architecture that generates text based on statistical relationships learned from a large amount of pre-existing text. The language model 302 can receive, from an application or computing system, a request for a textual summary 304A, 304B. The request for the textual summary 304A, 304B can include a textual prompt to the language model 302 and represents an intent for the respective requesting application/computing system. The language model 302 can respond to receiving the request for the textual summary 304A, 304B by generating a textual summary 306A, 306B based on the request for the textual summary 304A, 304B and the intermediate representation 106.

For example, a first request to provide a textual summary 304A of a type of activity can include a first prompt, “Summarize this user's top interests based on this user's activity.” The language model 302 can respond to the first prompt with a first textual summary 306A, such as, “This user is interested in professional football and pickup trucks.” A second request to provide a textual summary 304B of a type of activity can include a prompt, “Identify potential purchase intentions from this user's history.” The language model 302 can respond to the second prompt with a second textual summary 306B, such as, “This user may purchase a new mobile phone or a pickup truck.” The textual summaries 306A, 306B indicate intents of the user and are examples of the textual summaries 108A, 108B, 108C shown and described with respect to FIG. 1.

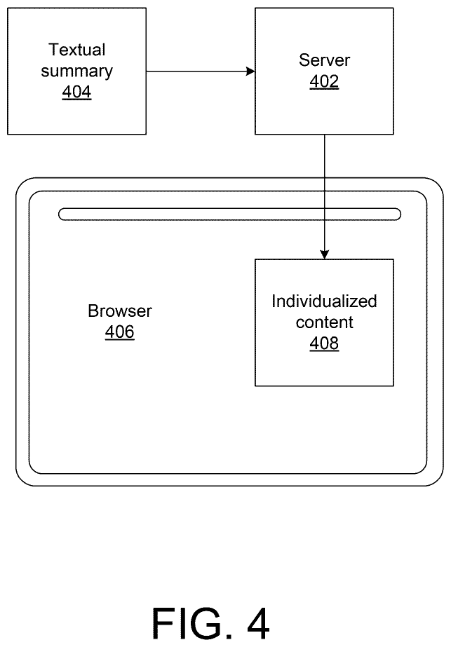

In some implementations, the textual summaries 304A, 304B are stored at a server in association with the user account and in association with an indication of the intent used to generate the profile summary. In some implementations, the language model or a system on which the language model runs may send, to the computing system, a textual summary generated for the intent (request for textual summary) provided by the computing system. In such implementations, the computing system can store the textual summaries 306A, 306B in association with a user profile. The computing system can store the textual summaries 306A, 306B for later use to generate individualized content 408, as shown and described with respect to FIG. 4. In implementations where a server stores the profile summaries, an application can request a profile summary for a user. The request can include an indication of the intent for which the profile summary was generated. The indication of the intent may be/include an indication of the application for which the profile summary was generated. The indication of the intent can include an identifier for the intent, a representation of the intent. A representation of the intent can be an embedding of the intent (the prompt), a sequence of words to be compared to a representation (embedding) of the intent, etc. The indication of the intent may include an identifier for an application and an identifier for the intent or a representation of the intent.

The generation of textual summaries 306A, 306B based on prompts to the language model 302 allows for a high degree of flexibility and adaptability in the system. The system can generate diverse and relevant user profiles for different purposes, ranging from product recommendations to targeted advertising, all from the same intermediate representation 106 (which can include cached information such as a KV cache). The use of the intermediate representation 106 for different requests for textual summaries 304A, 304B avoids reencoding the history of the user account for different applications, resulting in significant computational savings. The textual summaries 306A, 306B can be generated quickly, facilitating real-time personalization of applications and reducing latency when personalizing functions supported by applications. The same intermediate representation 106 can be reused for multiple applications and different types of profile summaries associated with different intents, promoting scalability to a large number of textual summaries 306A, 306B. The banking of resources across multiple applications may enable access to a more powerful language model within given constraints of computing resources. The textual summaries 306A, 306B occupy significantly less memory per user account than the intermediate representation 106 and significantly less memory than the activity history 102.

In some implementations, the system can generate textual summaries 306A, 306B that highlight recent search interests of the user account, preferred information sources of the user account, and/or reading level of the user account, enabling search results to be tailored, and/or relevant websites, articles, and/or videos to be promoted and/or ranked higher in search results for the user account. In some implementations, the system can leverage the textual summaries 306A, 306B to offer accurate and personalized query suggestions as the user account types into a search bar that provides search queries to a search engine. In some implementations, the system can leverage the textual summaries 306A, 306B to update knowledge panels based on interests of the user account, showcasing information that the user account is most likely to find engaging. In some implementations, the system can leverage the textual summaries 306A, 306B to surface personalized recommendations, suggest related topics, and/or explore areas of interest. In some implementations, the system can leverage the textual summaries 306A, 306B to personalize advertisements based on a language style and/or interests of the user account. In some implementations, the system can generate the textual summaries 306A, 306B based on shopping preferences, brand affinities, and/or price sensitivities of the user account.

In some implementations, the computing system deletes and/or erases the intermediate representation 106 after generating the textual summaries 306A, 306B based on the intermediate representation 106 and the requests for textual summaries 304A, 304B. Deleting and/or erasing the intermediate representation 106 can free memory resources for other tasks, such as generating an intermediate representation of activity history of another user account.

In some implementations, the computing system generates the intermediate representation 106 and textual summaries 306A, 306B repeatedly. In some implementations, the computing system generates the intermediate representation 106 and textual summaries 306A, 306B periodically, such as once per week, once per month, once every six months, or once per year. In some implementations, the computing system generates the intermediate representation 106 and textual summaries 306A, 306B based on additions to the activity history 102. The additions to the activity history 102 that cause generation of the textual summaries 306A, 306B can be a predetermined increase in time spent web browsing by the user account or a predetermined number of actions and/or tokens representing actions by the user account. The repeated generation of the intermediate representation 106 and textual summaries 306A, 306B can reflect changing interests of the user account.

FIG. 4 shows generation of individualized content 408 for a user account based on a textual summary 404. The textual summary 404 can include any of the textual summaries 108A, 108B, 108C, 306A, 306B described above. A computing system such as a server 402 can receive the textual summary 404. The textual summary 404 generated, with user permission, based on an intent and the user's history can describe interests and/or activities of the user account. Examples of the textual summary 404 are, “This user is interested in professional football and pickup trucks,” or, “This user may purchase a new mobile phone or a pickup truck.”

With explicit permission from the user account, the server 402 can send individualized content 408 to a browser 406. The browser 406 can be a web browser via which the user account is viewing webpages within the Internet. The browser 406 can execute on a computing system such as a desktop computer, a laptop or notebook computer, a tablet, a wearable smart device (e.g., XR glasses/headset), or a mobile phone such as a smartphone. The individualized content 408 can be based on the textual summary 404. For example, if the textual summary 404 is, “This user is interested in professional football and pickup trucks,” then the individualized content 408 can include an image showing, text describing, and/or a hyperlink to content related to, professional football or a pickup truck. In some examples, the individualized content 408 can be based on the textual summary 404 and information about a browsing state that the server 402 receives from the browser 406. The browsing state can include the webpage that the browser 406 is presenting, a time of day, or previous webpages that the user account has visited and/or viewed. The server 402 can send the individualized content 408 to the browser 406 based on the textual summary 404 and the browsing state, such as presenting professional football content in the afternoon and pickup truck content in the evening.

In some examples, the individualized content 408 can be included in search results. For example, the user account can enter a search query into the browser 406, and the server 402, based on the textual summary 404 and the search query, can provide search results based on the search query and the textual summary 404.

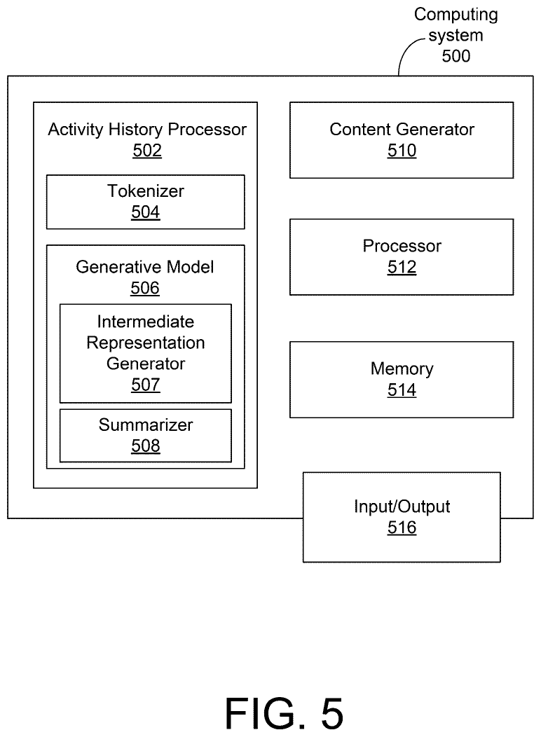

FIG. 5 is a block diagram of a computing system 500. The computing system 500 can implement the techniques described herein, such as generating the intermediate representation 106, logging the activity history 102, generating the requests for textual summaries 304A, 304B, generating the textual summaries 306A, 306B, and/or generating the individualized content 408. The functions described with respect to the computing system 500 can be performed by a single computing device or distributed between multiple computing devices.

The computing system 500 can include an activity history processor 502. The activity history processor 502 can process the activity history 102 to generate the intermediate representation 106.

The activity history processor 502 can include a tokenizer 504. The tokenizer 504 can generate the tokens 104 based on the activity history 102. The tokenizer 504 can generate the tokens 104 by analyzing the activity history 102 and determining discrete actions performed by the user account based on the activity history 102. The tokens 104 can represent the discrete actions as tokens. Information included in the activity history 102 that is not included in the discrete actions can be ignored and/or excluded from the tokens 104.

The activity history processor 502 can include a generative model 506. The generative model 506 can include a model based on a transformer architecture or similar architecture. A transformer architecture or similar architecture is a deep learning architecture based on a multi-head attention mechanism. The generative model 506 can generate an intermediate representation such as a KV cache and textual summaries based on given intents.

The generative model 506 can include an intermediate representation generator 507. The intermediate representation generator 507 can represent a first phase, e.g., a phase that processes the activity history of a user. The intermediate representation generator 507 can generate an intermediate representation of an activity history of a user. The intermediate representation generator 507 can, for example, generate the intermediate representation 106 based on the activity history 102 and/or tokens 104. The intermediate representation generator 507 can convert the tokens 104 into vectors via lookup from a word embedding table. In some implementations, the intermediate representation generator 507 also converts a textual description of the activity history 102 into the tokens 104.

The generative model 506 can include a summarizer 508. The summarizer 508 can represent a second phase, e.g., where the intermediate representation is re-used to generate multiple different profile summaries for different intents. The summarizer 508 can generate summaries, such as the textual summaries 108A, 108B, 108C, 306A, 306B, 404 based on intents, which may represent types of activities and/or interests to be identified in a user account based on the intermediate representation 106.

Although not illustrated in FIG. 5, in some implementations, the summarizer 508 and the intermediate representation generator 507 may use one or more generative models. For example, the summarizer 508 may request a language model to provide textual summaries of different intents with respect to the user account.

In some implementations, the summarizer 508 has a predetermined minimum and/or maximum length for the textual summaries. The predetermined minimum and/or maximum length can be measured in characters or words. The summarizer 508 (the generative model 506) can generate words for the summary in an autoregressive manner until a stopping criterion, such as being at least or greater than the minimum length and/or less than or no greater than the maximum length or generating an end-of-sequence token (such as a an end-of-sentence token such as a period, exclamation point, or question mark) being added, is satisfied.

The computing system 500 can include a content generator 510. The content generator 510 can generate content for a user account while the user account is browsing on a web browser and logged into the user account. The content generator 510 can generate the content based on the textual summaries. The content generator 510 can generate the content based on the textual summaries and the current activity of the user account. Although illustrated as part of the computing system 500 in FIG. 5, the content generator 510 can be implemented as a system remote from, but in communication with, computing system 500 (i.e., the activity history processor 502).

In some implementations, the content generator 510 can select, from multiple textual summaries, a selected summary. The selection of the summary can be based on a requested intent. The requested intent can be determined by the computing system 500, a web browser via which a user is viewing web content, a computing device on which the web browser is executing, or a server in communication with the web browser, as non-limiting examples. The requested intent can include a context of the user and/or web browsing activity, such as a query or search terms inputted by the user into a web browser, search engine, or chatbot, hyperlinks selected by the user, dwell time on webpages, addresses (such as Uniform Resource Locators) of visited webpages, and content of visited webpages, as non-limiting examples.

The requested intent can indicate an application identifier. In such implementations, the selected summary is associated with the user account and the application identified by the requested intent. The requested intent can include a representation of an intent (e.g., a prompt or a description of the types of use cases/activities/interests requested). In such implementations, the selected summary is associated with the user account and with an indication of the intent that is most similar to the requested intent In some implementations, the content generator 510 selects the selected summary based on the selected summary being similar to and/or related to the requested intent. For example, if the requested intent indicates that the user account is simply web browsing to read topics of interest (such as by viewing a webpage related to leisure pursuits), then the content generator 510 can select the first textual summary 306A, “This user is interested in professional football and pickup trucks,” whereas if the requested intent indicates that the user account is interested in making a purchase (such as by viewing an e-commerce webpage), then the content generator 510 can select the second textual summary 306B, “This user may purchase a mobile phone or a pickup truck.”

The content generator 510 can, for example, provide content that the textual summaries indicate that the user account is interested in while the user account is engaged in a related activity. In some examples, the content generator 510 provides content that the selected summary indicates that the user account is interested in. For example, if the selected summary indicates that the user account is interested in professional football, then the content generator 510 can provide, generate, and/or present content related to professional football while the user account is visiting a webpage related to college football because college football is related to professional football. If the selected summary indicates that the user account is interested in purchasing a mobile phone, the content generator 510 can provide content for the web browser to present that will assist the user in purchasing a mobile phone. The content can include an image, text, and/or hyperlinks, as non-limiting examples. In some implementations, the content generator 510 receives the content that is provided to the user from a server in communication with the web browser via which viewing content. The server 402 sending individualized content 408 to the browser 406, as shown in FIG. 4, is an example of the content generator providing content.

The computing system 500 can include at least one processor 512. The at least one processor 512 can execute instructions, such as instructions stored in at least one memory device 514, to cause the computing system 500 to perform any combination of methods, functions, and/or techniques described herein.

The computing system 500 can include at least one memory device 514. The at least one memory device 514 can include a non-transitory computer-readable storage medium. The at least one memory device 514 can store data and instructions thereon that, when executed by at least one processor, such as the processor 512, are configured to cause the computing system 500 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 500 can be configured to perform, alone, or in combination with computing system 500, any combination of methods, functions, and/or techniques described herein. The at least one memory device 514 can store data relied upon and/or generated by the computing system 500, such as the summaries 108A, 108B, 108C, 306A, 306B, 404.

The computing system 500 can include at least one input/output node 516. The at least one input/output node 516 may receive and/or send data, such as from and/or to, a server or a computing system on which a browser is executing, and/or may receive input and provide output from and to a user. The input and output functions may be combined into a single node, or may be divided into separate input and output nodes. The input/output node 516 can include, for example, a microphone, a camera, a display such as a touchscreen, a speaker, one or more buttons, and/or one or more wired or wireless interfaces for communicating with other computing devices.

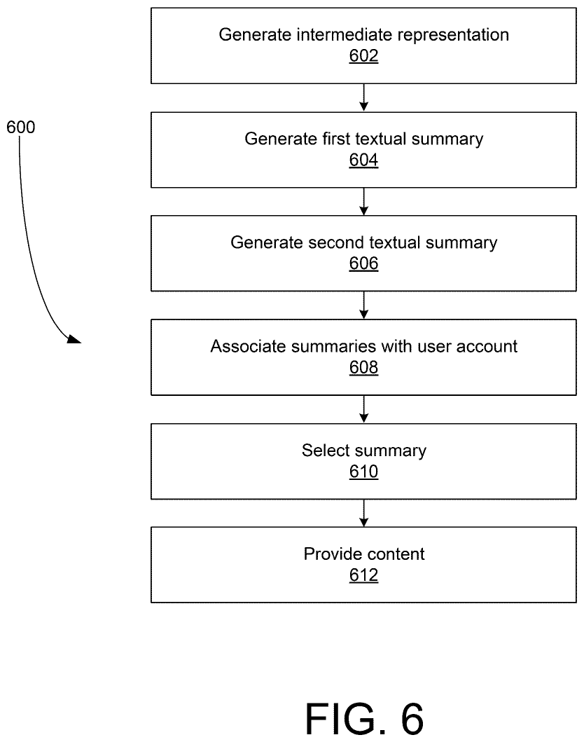

FIG. 6 is a flowchart showing a method 600 performed by the computing system 500. In The method 600 can include generating an intermediate representation (602). Generating the intermediate representation (602) can include generating, using a language model, the intermediate representation of an activity history of a user account based on actions performed with respect to a browser. The method 600 can include generating a first textual summary (604). Generating the first textual summary (604) can include, generating, using the language model, the first textual summary for a first intent based on the intermediate representation. The method 600 can include generating a second textual summary (606). Generating the second textual summary (606) can include generating, using the language model, the second textual summary of a second intent based on the intermediate representation. The method 600 can include associating summaries with the user account (608). Associating the summaries with the user account (608) can include associating the first textual summary and the second textual summary with the user account. The method 600 can include selecting a summary (610). Selecting the summary (610) can include selecting, from the first textual summary and the second textual summary, a selected summary based on a requested intent. The method 600 can include providing content (612). Providing content (612) can include providing content based on the selected summary.

In some implementations, the intermediate representation indicates relationships between the actions performed with respect to the browser.

In some implementations, the method further includes deleting the intermediate representation after associating the first textual summary and the second textual summary with the user account.

In some implementations, the first intent includes a prompt associated with a first application and the second intent includes a prompt associated with a second application.

In some implementations, the intermediate representation includes a key-value cache of tokens representing the activity history.

In some implementations, the intermediate representation is generated using attention maps of the language model that processes the activity history.

In some implementations, providing the content based on the selected summary includes providing the content in a response to a search query.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
generating, using a language model, an intermediate representation of an activity history of a user account based on actions performed with respect to a browser;
generating, using the language model, a first textual summary for a first intent based on the intermediate representation;
generating, using the language model, a second textual summary of a second intent based on the intermediate representation;
associating the first textual summary and the second textual summary with the user account;
selecting, from the first textual summary and the second textual summary, a selected summary based on a requested intent; and
providing content based on the selected summary.

2. The method of claim 1, wherein the intermediate representation indicates relationships between the actions performed with respect to the browser.

3. The method of claim 1, further comprising deleting the intermediate representation after associating the first textual summary and the second textual summary with the user account.

4. The method of claim 1, wherein the first intent includes a prompt associated with a first application and the second intent includes a prompt associated with a second application.

5. The method of claim 1, wherein the intermediate representation includes a key-value cache of tokens representing the activity history.

6. The method of claim 1, wherein the intermediate representation is generated using attention maps of the language model that processes the activity history.

7. The method of claim 1, wherein providing the content based on the selected summary includes providing the content in a response to a search query.

8. A non-transitory computer-readable storage medium comprising instructions stored thereon that, when executed by at least one processor, are configured to cause a computing system to:
generate, using a language model, an intermediate representation of an activity history of a user account based on actions performed with respect to a browser;
generate, using the language model, a first textual summary for a first intent based on the intermediate representation;
generate, using the language model, a second textual summary of a second intent based on the intermediate representation;
associate the first textual summary and the second textual summary with the user account;
select, from the first textual summary and the second textual summary, a selected summary based on a requested intent; and
provide content based on the selected summary.

9. The non-transitory computer-readable storage medium of claim 8, wherein the intermediate representation indicates relationships between the actions performed with respect to the browser.

10. The non-transitory computer-readable storage medium of claim 8, wherein the instructions are further configured to cause the computing system to delete the intermediate representation after associating the first textual summary and the second textual summary with the user account.

11. The non-transitory computer-readable storage medium of claim 8, wherein the first intent includes a prompt associated with a first application and the second intent includes a prompt associated with a second application.

12. The non-transitory computer-readable storage medium of claim 8, wherein the intermediate representation includes a key-value cache of tokens representing the activity history.

13. The non-transitory computer-readable storage medium of claim 8, wherein the intermediate representation is generated using attention maps of the language model that processes the activity history.

14. The non-transitory computer-readable storage medium of claim 8, wherein providing the content based on the selected summary includes providing the content in a response to a search query.

15. A computing system comprising:
at least one processor; and
a non-transitory computer-readable storage medium comprising instructions stored thereon that, when executed by the at least one processor, are configured to cause the computing system to:
generate, using a language model, an intermediate representation of an activity history of a user account based on actions performed with respect to a browser;
generate, using the language model, a first textual summary for a first intent based on the intermediate representation;
generate, using the language model, a second textual summary of a second intent based on the intermediate representation;
associate the first textual summary and the second textual summary with the user account;
select, from the first textual summary and the second textual summary, a selected summary based on a requested intent; and
provide content based on the selected summary.

16. The computing system of claim 15, wherein the intermediate representation indicates relationships between the actions performed with respect to the browser.

17. The computing system of claim 15, wherein the instructions are further configured to cause the computing system to delete the intermediate representation after associating the first textual summary and the second textual summary with the user account.

18. The computing system of claim 15, wherein the first intent includes a prompt associated with a first application and the second intent includes a prompt associated with a second application.

19. The computing system of claim 15, wherein the intermediate representation includes a key-value cache of tokens representing the activity history.

20. The computing system of claim 15, wherein the intermediate representation is generated using attention maps of the language model that processes the activity history.
